(19) United States
(12) Patent Application Publication
(10) Pub. No.: US 2005/0193789 A1
(43) Pub. Date: Sep. 8, 2005

(54) METHOD FOR TREATING BIOLOGICAL WASTE

(75) Inventor: GALEN W. HARTMAN, KEMP, TX (US)

Correspondence Address: BAKER & MCKENZIE;PATENT DEPARTMENT, 2001 ROSS AVENUE, SUITE 2300, DALLAS, TX, 75201, US

(73) Assignee: B.H.S., INC., RENO, NV (US)

(21) Appl. No.: 10/905,548

(22) Filed: Jan. 10, 2005

Related U.S. Application Data
(60) Provisional application No. 60/481,873, filed on Jan. 8, 2004.

(51) Int. Cl. A01G 1/00

(52) U.S. Cl. 71/1

(57) ABSTRACT

A process for treating animal and plant waste includes chemical treatment to deodorize the waste and kill bacteria, to obtain a desired nutritional balance, and to ensure desired product properties. The treated waste is also treated to inactivate seeds, and hammermilled for physical and chemical consistency. The material is sized and formed into a final product that can be further treated or used as such. The material can also be treated with microbial agents, sterilized by thermophilic anaerobial and thermal means. Configuration of the process steps can be varied over a considerable range.

### CROSS-REFERENCE TO RELATED APPLICATION

This Application claims the benefit of U.S. Provisional Application Ser. No. 60/481,873, filed on Jan. 8, 2004, and entitled “Process for Treating Biological Waste,” which is commonly assigned with the present application and incorporated herein by reference for all purposes.

### BACKGROUND OF THE INVENTION

Animal and plant waste products have been used to make useful materials such as fertilizers and plant nutrients since ancient times, and their drawbacks are well known. Numerous methods have been devised to overcome these drawbacks, but these methods usually also eliminate the benefits of using these materials. U.S. Pat. No. 5,730,772, issued to Staples on Mar. 24, 1998 discloses a method of producing a high nitrogen content plant nutrient from poultry manure with a slow nitrogen release mechanism. U.S. Pat. No. 4,177,575, issued to Brooks on Dec. 11, 1979 discloses a method of drying a feedstock using two-stage drying at different stage temperatures. The equipment used for drying also mills and pelletizes the material, but no deliberate effort is made to eliminate odors and pathogens, or to ensure any particular chemical or biological properties in the resulting product. U.S. Pat. No. 4,034,078, issued to Van Horn on Jul. 5, 1977 discloses a product for controlling odor in waste and method of controlling odor in animal waste using the product. The product is an admixture of a ferrous salt and an enzyme, and mixed with or spread on top of the waste material.

In many of these prior art processes, a significant amount of the nitrogen and other beneficial components are volatilized or lost in the process or chemically modified to an unusable form, and are not biologically available. Also, odor reduction has not proven to be as affective as claimed for many prior art processes. Furthermore, in these prior arts, products have reduced odor when dry, but become objectionably malodorous when wet. In such cases, the products can be applied with acceptable odor, but when the products are watered with sprinklers or rainfall, they produce obnoxious and unacceptable odors.

Therefore, there exists a need for improved compositions and processes of organic and natural ingredient treatment of animal and plant waste, as well as processed animal and plant byproducts including industrial agricultural waste byproducts such as ethanol production facilities that utilize plant feedstocks. In particular, there is a need for a method of converting animal and plant waste into rigid and gelled poke sticks; liquefied emulsion composition; and other application means of natural and organic nutritional plant or animal feeds capable of being certified as “organic”, having reduced odor and improved nutrient efficacies with decreased phosphate, nitrate, and other undesirable component contents while minimizing the deterioration and destruction of nutrient components inherent in waste. No known process combines the steps of the present invention to produce both animal feed products and plant nutrient products by reconfiguring the process flow sequence and the reactants used.

### SUMMARY OF THE INVENTION

Throughout this patent, the word “organic” used by itself has the ordinary meaning given it in the field of organic chemistry, but when it occurs in the term “certifiable as organic”, the word is used as defined by OMRI (Organic Material Registry Institute) and USDA NOP (United States Department of Agriculture National Organic Program) as “organic”, which includes inorganic and organic chemical ingredients derived from plants, animals, and earth source components. The word “natural” when used to describe products or their components is defined as “being of neat earth derivation source components and neat earth components and components and products certifiable as organic.” Also, the word “plant” used by itself has the ordinary meaning of horticultural description associated with a wide range of horticultural species especially but not limited to grasses, flowers, shrubs, trees, garden or house plants. Finally, the word “neat” when used to describe components is defined to mean “unmixed with anything, undiluted, straight, free of deductions or additions, being of original composition, unchanged.”

The terms, which include in part, “spike, poke sticks, probes, gel sticks”, or other terms and components known in the art or that will become known in the art as substitutes used in the industry for rigid application forms of plant nutrients or applicable components are referred to as part of poke sticks in this invention, while the terms, which include in part, “liquid, emulsified composition, liquefied emulsion”, or other terms and components known in the art or that will become known in the art as substitutes used in the industry for rigid application forms of plant nutrients or applicable components are referred to as part of liquefied emulsion in this invention.

One embodiment of the present invention converts animal and plant waste as well as processed plant byproducts into natural and certifiable as organic nutritional plant and animal feeds, by utilizing predominately natural components and certain processes that allow waste to be deodorized with minimum deterioration of the nutritional components in the waste to produce deodorized waste in powder, prills, pellets, beads, liquids, various rigid forms, dispensing forms including, in part, gelled, liquid, emulsion, dispersion, solid, or other forms. Further processing of the waste with predominately natural components allows for a large number of products to be produced that are nutrients for a wide range of plants, including in part, grasses, trees, garden and house plants, shrubs, and flowers, as well as animal nutrients for a wide range of animals, including in part, chickens, cattle, horses, sheep, hogs, turkeys, dogs, and cats.

Typical plant fertilizers and plant nutrients as well as animal and plant waste commonly have high pH water extracts that limit their dosage rate range, so the types of grasses or plants that can utilize such fertilizers or plant nutrients without chemically burning of the grasses or plants are limited. The resulting fertilizers or plant nutrients have sensitive dosage limits, short nutritional periods, and provide improper application of chemical concentrations to the grasses and plants. An alternative embodiment provides means to convert fertilizer or plant nutrient components inherent in waste that would normally yield high pH water extracts into a chemical complex that provides the full nutritional value of the fertilizer or plant nutrient components in near neutral pH complex components that is easily metabolized by the grasses and plants and has a time release period of the fertilizer or plant nutrients. Thus, a wider range of grasses and plant types will be able to utilize the fertilizer or plant nutrient and there will be less sensitivity to dosage rate ranges with the present product than with conventional fertilizer or plant nutrient components made from waste. Furthermore, problem fertilizer and plant nutrient components such as nitrates and phosphates which contribute to serious environmental problems such as contamination of surface water, rivers, water ways, and aquifers, can be chemically reduced using yet another embodiment of the invention so that they are not as water soluble yet are still available for grass or plant uptake and metabolization.

The process of yet another embodiment utilizes predominately natural components so that resulting products will be certifiable as organic, having reduced odor in both dry and water wet forms, and improved nutrient efficacies with decreased phosphate, nitrate, and other undesirable component contents. These qualities are achieved through chemical and process means that minimize the deterioration and destruction of the nutrient components inherent in the waste. Also, the embodiment keeps process temperatures below where beneficial components, such as ammonium compounds, nitrogen bearing compounds, and others, pyrolytically decompose and/or volatilize.

Yet another embodiment provides processes and natural components introduction based on real-time chemical analysis, monitoring, and control. The preferred embodiment allows identification of ingredient compositional recognition, inputting target product composition values so that the process and introduction of natural ingredients are controlled where the final product is produced more accurately and uniformly with minimum batch-to-batch variation. The embodiment utilizes chemically balancing means and guides the processes so that chemical reactions, process types, and reaction types coordinate efficaciously to target the final product's desired composition.

The invention utilizes processes to maximize chemical exposure of feedstock components, which accelerates and maximizes chemical reactivity and extents of reaction at minimal temperatures.

The invention also utilizes processes for sterilization of pathologic microbes and inactivation of undesired grass, plant, and weed seeds by various chemical, biological, and thermal processes that emphasize minimal temperature exposure and deterioration of beneficial components in the feedstocks and added ingredients.

The invention utilizes processes and natural components to produce products with uniform particle size and narrow particle size distribution, which provides benefits for applying the product more uniformly with commercial nutrient spreaders. Environmental benefits are also realized due to decreased dust or small particle components in products.

In yet another embodiment of the invention provides means to supplement the product with growth regulators, beneficial microbial components, stabilizers, and aesthetic components such as fragrances, flavoring, and color.

The invention further identifies processes that are applied to neat or processed animal and plant waste components in solubilized, emulsified, dispersed, powdered, prilled, pellitized, baled, or other physical forms. Sources of waste include, in part: house and barn litter or residue from horses, cattle, hogs, sheep, chickens, turkeys, quail and other livestock; manure from horses, cattle, hogs, sheep, chickens, turkeys, quail and other livestock; hay; silage; cotton mill components; crop or grass components, industrial waste and by-products, in part, ethanol production facilities that utilize agricultural feedstocks; and other plant and animal waste components known in the art or that will become known in the art as substitutes or applicable components.

The invention further provides means to produce end use products for plants that are, in part of total products, all natural and/or certifiable as organic nutrients for lawn, tree, shrub, turf, plant bed, garden, vegetable, fruit, and flower fertilizers that are designed for: 1) fall application for root growth, healthier stems, and rebuilding the soil; 2) winter application for providing cold weather hardiness to roots and plants; 3) spring application for providing root stimulation and upper plant growth and vigor; 4) summer application for providing root and upper plant nutrition, leaf greening, increased drought resistance, increased plant uptake of moisture and nutrients; 5) crab grass and weed control and prevention; 6) insect control and prevention; 7) winterizing roots and plants; 8) hardwood plants; 9) St. Augustine grass brown patch prevention; 10) root enhancement of jasmine and ivy beds; 11) vegetable garden plants; 12) roses and specialty plants; 13) promoting aggressive blooming performance of flowering plants; 14) balanced potting plants; and 15) specific grass or plant seeding that has the grass or plant seed encapsulated in the prills. In addition, the product in various compositions can be made as a solid biodegradable stake that can be forced into the soil to be utilized for inside potting plants and outside trees and larger plants.

The invention provides yet another means to produce plant and animal nutrients that have balanced nutritional parameters that facilitates plant and animal health and growth. Plants that have been fertilized with invention nutrients are seen to have significantly increased uptake rates of components from the soil. The invention nutrients are generally based on a buffered near neutral pH composition. This allows a much broader variation of plants to be fertilized with these products. Plants, such as azaleas, dogwoods, hollies, wisteria, camellias, and certain other plants and grasses, that inherently prefers to grow in an acidic soil, below pH 7.0 and generally between 4.0 to 5.5 pH, respond very well to being fertilized with invention products. Such plants are observed to grow and thrive better when fertilized with invention products than with special acidic commercial fertilizer or plant nutrients provided for such applications. Plants that inherently prefer to be grown in alkaline soils, above pH 7.0, are similarly observed to respond well to invention products. Alkaline soils especially limit the plant availability of cationic chemical species in the soil such as, in part, iron, magnesium, manganese, selenium, and zinc. The invention products being organic in composition aid the soil by acting more as an acidic influence on soils, which make cationic components in soil more available to the plant. These cationic components include metallic and trace elements in the soil that the plant need in their proper nutrition balance.

Due to the invention products' buffered pH and organic composition, plants treated with products of the invention exhibit less chemical burning of plants, when compared to commercial products, as plants are exposed to application dosages of nutrients that are greatly above recommended amounts. For example, grasses that are mature in the growing stage prior to seed head production are observed to do well even when application dosages are increased greatly above recommendations. If such grasses are exposed to invention products being piled onto the ground so that some of the grass is covered completely, the grass at the perimeter of the nutrient pile will thrive.

Plants that are in stress of growing from factors associated with soils, chemical contaminations, herbicides, and some insects are observed to respond well to invention products. Household plants that show growth problems are typically seen to respond well when fertilized with invention products.

The invention further provides means and processes to produce plant nutrients that increase the germination rates of seeds to as much as three (3) times normal. Seeds planted with plant nutrients produced by the invention are observed to have significantly more germinated vigor and dynamism. Seed sprouts, known as germinates, have much greater heartiness, verve, and vitality. Germinates produced with the invention nutrients are observed to have significantly larger bodies with greater chromophore content being much darker in color. Green germinates are seen normally as pale green early in development whereas germinates produced with invention nutrients are much darker in green color. For example, common Bermuda seed planted under typical conditions are nominally observed to sprout and be visibly seen in about 18 to 21 days; the same seed when planted with the invention nutrients are observed to sprout and be visibly seen in 6 to 8 days under the same ambient conditions. Beyond the benefits of such early plant development for generating healthy grass areas, there are many other benefits such as soil support, which minimizes erosion tendencies, and creating grasses that will resist many other maladies that plants can be exposed.

The invention further utilizes means to produce plant nutrients that provide remarkable top growth and health of plants. Plants that have been fertilized with invention nutrients respond rapidly to developing darker foliage, much higher foliage mass and thickness, foliage height and spread, strength of foliage, as seen as foliage being more vertical without typical drooping, culms structures that have more physical integrity, thicker blades, ligules, auricles, and sheaths, darker color hues, and less drought sensitivity. The darker hue of foliage enhances greater adsorption rates of ultraviolet light radiation from sunlight, which increases photosynthesis in the plants.

Below-ground plant components fertilized with the embodied products have more root mass, dimensional increase of the root system, and heartiness of roots. Grasses that have stolon and rhizome root systems exhibit comparably more propagation and lineation. Vegetative shoots are increased quantitatively. Grasses that are stolon and rhizome types when growing next to concrete and paved areas will shoot stolons, rhizomes, and vegetative shoots out onto such surfaces due to the nutritional drive of the plants.

Soils that have been contaminated with, in part, solvents, chemicals, herbicides, insecticides, fuels, oils and the likes to an extent that the ground is sterilized for plant growth are revitalized with invention products. Invention products applied to such soils that have been sterilized for years where plants will not grow are revitalized readily in short periods of time. Experimental plots of soil that have been sterilized with diesel fuel to prevent plant growth have been treated with invention products as well as conventional fertilizers and grass seed in adjoining areas as test comparisons. Results of such experimentation illustrates revitalization of soil in the invention product treated area for which the soil was revitalized for grass growth, in comparison to the experimental control area that remained sterilized.

Flowering household plants, shrubbery, trees and bushes exhibit enhanced color hues of flowers as well as the amount of flowers when fertilized with invention products.

Comparing invention products to conventional fertilizers at the same nitrogen, phosphorus, and potassium (NPK) contents compositely and individually when applied to plants has shown that the invention products provide significantly improved performance in plant growth and vigor. Texas A&M University's (TAMU's) Texas Agricultural Experimentation Station Research and Extension Center in Dallas, Tex. evaluated the invention product comparatively with commercial fertilizers. The TAMU report (copy attached in the Appendix) was a comparative study where equivalent nitrogen, phosphorous, and potassium levels were studied separately. The study was primarily conducted on Tifway Bermuda grass as well as other grasses. The soil was Austin silty clay, which is typical of Blackland soil. The dosage rates varied from 0 to 80 lb of nitrogen equivalent per 1000 ft². The results based on clipping mass of the first cut (after 4 weeks) indicated that the invention product had a 29% greater clipping mass than the commercial fertilizer at 20 lb per 1000 ft² dosage rate and 20% greater clipping mass at 80 lb per ft² dosage rate. The invention product was observed to have improved plant color and structural development. Based on dosage rates that have been studied for the embodied product, it is seen that dosage rates of 8 lb per 1000 ft² are quite effective on this type of grass.

The end use products for animal feeds are all natural and/or certifiable as organic products that include feed supplements and finished products for, in part, horses, cattle, chickens, turkey, quail, fish, dogs, cats, and other animals.

Yet another embodiment of the invention provides a composition and process for producing a slow release plant nutrient. Generally, this composition comprises a mixture of resins and other binder components with the embodied product plant nutrients. The mixture can also be used to form different structural forms and sizes. The embodied product can be incorporated with thermoplastic, thermosetting, chemically bonding, and neat resins to create rigid forms. Examples of resins include thermoplastics with lower melting points, which include, in part, polyaliphatics, polyallyls, polyallylesters, polyallylethers, and polyallylalcohols. The composition formed can also be an effective and economical encapsulated plant nutrient with a slow release mechanism. The slow release mechanism of the present embodiment is further influenced by the amount of resin used in making the composition. The resin is generally present in the composition in an amount of from about 2% to about 40% by weight. The embodiment also provides means to produce liquid plant nutrient products that can be applied in a gravity feeding root spike. This application utilizes a poke stick, typically plastic, that is supplied with liquid plant nutrients from a reservoir. The embodiment further provides for a physically resistant plant nutrient poke stick composition capable of being pushed or hammered into the ground. The composition comprises about 90% by weight of plant nutrient compounds and about 10% by weight of resin coatings with adequate mechanical strength to provide the necessary physical integrity. The poke sticks are shaped for hammering into the soil. The embodied products can be fashioned many ways to accomplish application by hand or machine means.

Yet another embodiment of the invention provides a composition and process for producing a liquefied emulsion plant nutrient. Generally, this composition comprises a mixture ingredient components and process means to produce liquefied emulsion plant and animal nutrients. The liquefied emulsion plant nutrients can be used in different forms. The embodied product can be incorporated with desirable plant seeds to seed areas being fertilized. The embodied product can also be rapidly applied to large areas with spraying equipment to provide ground and plant nutrition without risk to burning plants. The compositions formed are effective and economical liquefied emulsion plant nutrients with a slow release mechanism. The slow release mechanism provides an increased half-life clearance of the soil and in the plants and complements a longer effective period of time for the plant nutrient. The slow release mechanism of the present embodiment is further influenced by the amount of organic content and ratio of water soluble to non-water soluble content in the composition. The embodiment also provides means to produce liquefied emulsion plant nutrient products that can be applied in areas sensitive to erosion and soil migration. The embodied products provide soil binding effects and surface water resistance to aid in erosion control. The embodiment provides products that revitalize soils that are environmentally compromised or sterilized as a result of being exposed to chemicals, solvents, pesticides, herbicides, and other biostatic agents. The embodied products can be fashioned many ways to accomplish application by hand or machine means. The embodied products can be pressure injected into water irrigation lines to provide plant nutrition while watering and irrigating.

Cattle and horses are commonly fed supplements and nutrition products from a tank that have wheels that extend down into a liquid nutritional mass that is supplied to the animals when they lick the wheels causing the wheels to roll and pick up the nutrient. The embodiment further provides means to produce products that are for animal nutrition in a liquefied emulsion form to be supplied to animals by applying it to dry animal feeds, as well as supplied in liquid feeders, such as, in part, wheel feeders, reservoir feeders, gravity feeders, liquid feeders, etc. The embodied products are in a water-laden emulsion when produced and applied; therefore, the odor reduction has been accomplished to a high degree to not be objectionable. No known process combines the steps of the present invention to produce plant nutrient products by reconfiguring the process flow sequence and the reactants used.

In general, a method having the desired features and advantages can be achieved by performing several component processes in parallel, in series, in combination, in tangential sequence, or in parallel loops, the exact configuration being dependent on the particular application and product type and application. Real-time chemical analyses can be used to govern in-situ processing and sequencing. The separate processes include:
(1) Grinding, hammer-milling, blending, and mixing waste stock to create uniformity of composition and minimizing particle size for enhancing maximum chemical exposure;
(2) Chemical treatment for odor reduction, chemical balance, and bactericidal treatment;
(3) Inactivation of undesired grass, plant, or weed seeds;
(4) Sterilization and abatement of pathologic microbes and bactericidal treatment with anaerobic, aerobic, aerobic exothermal, thermophylic processes, osmotic cellulolysis, addition of natural and synthetic components, and/or temperature processing;
(5) Particle forming of materials into prills, pellets, beads, powders, or various other physical forms of materials while controlling particle size and size distribution and particle chemistry;
(6) Preparation of component solutions, emulsions, dispersions, or chemical reaction products to be used as addition components for processing, treatments, nutrition, and final product parameters;
(7) Preparation of admixtures;
(8) Preparation of encapsulates and encapsulated components;
(9) Real-time analyses of chemical and nutritional composition to control in-situ processes and component additions;
(10) Incorporating desired specific grass or plant seeds into product particles;
(11) Moisture control during processing and final product manufacturing by chemical, thermal, or other means of drying;
(12) Perform specialty ingredients and aesthetic component additions such as the adding and blending of beneficial microbials, product stabilizers, growth regulators, fragrances, flavors, colorants, encapsulates in product, and other beneficial ingredients in the product; and
(13) Packaging.

Each of the component processes listed immediately above will now be described in greater detail.

1. Grinding, hammer-milling, blending, and mixing waste stock to create uniformity of composition and minimizing particle size for enhancing maximum chemical exposure.

Unprocessed raw waste feedstocks can be processed by grinding, hammer-milling, mixing, or blending the stock so that it has small particle size and is homogeneous in composition. During such processing, odor reduction, chemical treatments can be utilized in series, parallel, or perpendicular sequences.

Processed waste feedstocks, such as, in part, prilled, pellitized, beaded, powdered, or various other physical forms of the waste feedstock can also be processed by blending or mixing. For such feedstocks, the degree of shear can be decreased to maintain the form of the feedstock without unduly fracturing it. Chemical treatments are utilized during mixing and blending to reduce odor, treat pathological microbes, establish uniform particle size, incorporate and form dust and small particle size components into uniform particle sizes similar to the balance of the product and decrease the particle size disparity. Grinding and hammer-milling would not be used on the processed waste except for fractions that are separated out due to screening, etc.

2. Chemical treatment for odor reduction, chemical balance, and bactericidal treatment.

Chemical treatments for reducing odor and pathological microbes should be initiated as soon as possible, especially with unprocessed raw waste feedstocks. Such feedstocks should be chemically treated as soon as they are handled, introduced to storage, or processed. Preferably, chemical treatment should be applied to the raw feedstock as it is being stored in containers or bins by appropriate addition means.

The chemical treatments for odor and pathological microbes are not as demanding for dry processed waste feedstocks where some odor reduction and sterilization has occurred previously. Such feedstocks can be stored and introduced into the process sequence when product runs are initiated. However, odor reduction and treatment of pathological microbes can begin during handling or introducing into storage. Various dry processed feedstocks differ greatly and should be handled appropriately.

Water and chemical reactants as well as beneficial microbes are preferably introduced as far forward in the process as possible so that maximum times of chemical reactivity, chemical interactivity, and biostatic activities can occur. Also, the chemical reactant solutions are allowed to come in contact with the matrix of the raw feedstock thereby having more complete and intimate contact with components that are reacted and/or converted. In addition, this allows longer time periods during the process for attenuating the moisture content in the processed product, which generally is accentuated towards the end of the process. Typically, the final products will have relatively low moisture content. Moisture will volatilize under ambient and elevated conditions following Raoult's Laws of Partial Vapor Pressures, which will be accelerated by mixers and blenders in the process. These design factors are beneficial in minimizing temperature demands for driving such processes, which prevents exposing beneficial components to thermal decomposition and vaporization.

Phosphate and nitrate components in natural and organic ingredients as well as existing plant nutrients and their products contribute to contamination of surface water, rivers, and aquifers and create major environmental problems. For example, Oklahoma has recently filed a lawsuit against Arkansas over phosphate and nitrate surface run off from plant nutrient use and chicken house litter, hog farm waste, and other animal waste being used as plant nutrient on lands in the Arkansas flood plain of the Illinois River, which flows into Oklahoma. A newspaper article in the Arkansas Democrat Gazette, Special Section K, on Sunday, Aug. 11, 2002 outlines such problems and is based, in part, on an Oklahoma State University Clean Lake Study in 1997. The newspaper article illustrates that the problem is national. Using the present embodiments, the end-use products can be redox chemically reduced to minimize the presence of nitrates and phosphates. By redox chemical reduction, the phosphates and nitrates are in less oxidized forms, which allows the nitrogen and phosphate ionic radicals to be available for oxidation and metabolic processes in plants and animals.

Natural and organic chemicals and chemical admixtures can be utilized to minimize the presence of phosphates and nitrates by the redox chemical reduction into chemical forms primarily utilized by plants and that are compatible for accelerated plant uptake rates and microbial metabolizing processes. Therefore, phosphates and nitrates are not as available for surface run off resulting in stream, river, and aquifer contamination. In addition, the invention provides improved solubility control and biodegradation of the product so that the rate of penetration into the soil and uptake by the plant is increased and accelerated, and therefore less is available to leach, or transfer with surface water run off into water ways and aquifers.

In addition, the following component processes can be performed: 1) chemical balancing to obtain proper chemical stoichiometry of reactions and the proper composition of the final products; and 2) bactericidal treatment for inactivation of pathogenic bacterium and microbes.

The natural and organic chemical reactants can be solid, liquid, or gas. A non-exhaustive list includes ammonia, oxygen, carbon dioxide, nitrogen, ammonium salts, amine salts, ferrous compounds, ferric compounds, organic chromium compounds, cationic chromium (III) compounds, organic nickel compounds, organic selenium compounds, organic arsenic compounds, barium salts, potassium salts, sodium salts, lithium salts, metal and cationic proteinates, quaternary ammonium halides and anions, magnesium salts, calcium salts, manganese salts, cobalt salts, copper salts, zinc salts, sulfate compounds, manganese compounds, organic lead compounds, nitrate compounds, cationic and organic NOx, phosphate compounds, carbonate compounds, cationic and organic COx, bicarbonates, sulfates, sulfites, sulfonates, cationic and organic SOx, hydroxides, alums, mineral ores, zwitterions, copperases, chlorophyll, waxes, d-limonene, plant oils, seed oils, animal oils, pectin, thixotropes, whey solids, milled grains, celluloid particles and fibers, diatomaceous agents, crystalline silicas, dimeric carboxylic acids, dibasic alkylarylglycols, polybasic polymers, primary amine compounds, secondary amine compounds, tertiary amine compounds, molasses, sorghums, carbohydrates, plant carbohydrates, starches, polyalkylaryloxiranes, barites, non-newtonian agents, polyesters, polyarylcarboxylic acids, polyaliphatics, polyalkylcarboxylic acids, polyarylalkylglycols, aryl and alkyl dicarboxylic acids, terephthalic acids, succinic acid, adipic acid, 1,4-butanediol, ethylene glycol, propylene glycol, neopentyl glycol, gibberellins, cytokinins, kinins, dicocoamine, dimethylcocoamine, isoureas, isothioureas, lactams, auxins, brassins, triacontontanols, alkanol, sideromycins, humic acids, humates, 1-aminocyclopropane-1-carboxylic acid; triazole and imidazole substituted compounds with ketones, alcohols, hydroxyketones, diketones, and diols; and quaternary ammonioalkane carboxylic acid anilides, polymeric quaternary ammonium compounds, alkyl/aryl quaternary ammonium compounds, oxopyrimidines, arylcarboxy pyridones, individually or in mixture or chemical reaction product combinations as well as other natural and organic chemical reactants known in the art or that will become known in the art as substitutes or applicable reactant components.

3. Inactivation of undesired grass, plant, or weed seeds.

Typically, animal and plant waste contain active horticultural seeds capable of germination and growth under acceptable conditions. Plant nutrients made from such waste is desirous to not have these seeds being capable of growth; therefore, the seeds must be inactivated.

The seed inactivation process can employ thermal, chemical, or biological inactivation of the seeds through, in part, thermal processing, chemical processing, biological processing, microbial processing, aerobic and anaerobic processing, mechanical and physical destruction by hammer-milling, roller milling, ball milling, individually or a combination of such which may be known in the art or that will become known in the art as substitutes or applicable means, processes, or applications.

4. Sterilization and abatement of pathologic microbes and bactericidal treatment with anaerobic, aerobic, aerobic exothermal, thermophylic processes, osmotic cellulolysis, addition of natural and synthetic components, and/or temperature processing.

Vital microbial pathogens, like fertile seeds, should usually not be present in the final compositions. The process can also employ thermal and chemical inactivation and beneficial microbial agents for the treatment of microbial pathogens.

A non-exhaustive list of microbial strains that have proven useful, either alone or in combination of two or more types, are: Bacillus licheniformis, Bacillus subtilis, Bacillus lentimorbus, Bacillus thuringiensis canadensis, Brevundimonas vesicularis, Cellulomonas flavigena, Corynebacterium ammoniagenes, Pseudomonas aeruginosa, Rhodoccus chubuensis, Actinomycete, Clostridium pectinovorum, and those known in the art or that will become known in the art as substitutes or applicable microbial agents and microbial applications.

5. Particle forming of prills, pellets, beads, powders, or various other physical forms of materials while controlling particle size and size distribution as well as particle chemistry of prills, pellets, beads, powders, or various other physical forms of natural and organic ingredients.

Feedstocks that are processed through hammer-milling or other means that pulverizes or mechanically reduces the material to very small particles can be subsequently processed through means of this invention that will enlarge the small particle sizes and narrow the size distribution. Pulverized products that are to have a classical form will need to be formed into such forms, in part, prills, pellets, beads, etc. To accomplish this, it is necessary to process the material with, in part, prilling, beading, or extrusion means. The product of such means generates a wide disparity of particle sizes, which can be narrowed for particle size disparity and uniform product through means of this invention.

6. Preparation of component solutions, emulsions, dispersions, or chemical reaction products to be used as addition components for processing, treatments, nutrition, and final product parameters.

Component solutions, emulsions, dispersions, chemical reaction products utilized in this invention are prepared with an emphasis of maximum effective concentrations and minimum water and volatile concentrations. End use and applications forms that utilize rigid forms, such as poke sticks or liquefied emulsion, will benefit from products created by component solutions, emulsions, dispersions, and chemical reaction products that are high solids and providing physical integrity to the produced form. Other application forms, such as liquids, emulsions, dispersions, and gels, the processed components are designed to contribute to these application forms. Solutions are designed to allow solubility of solutes down to lower limits of temperature. Emulsions and dispersions are designed to maintain stable laticies and micelliae structures. Chemical reaction products that are tangential additions to the process where chemical reactions are conducted separate of the series product process and are designed to produce reaction products with minimum residual reactants. The chemical reaction products are designed to have minimum carrier solvent, such as water when added to the product process.

7. Preparation of admixtures.

Admixtures are components that are prepared separate of the process of materials that contribute to the stability and physical properties of the products. The invention provides for preparation of admixtures.

8. Preparation of encapsulates and encapsulated components.

Encapsulates and encapsulation components are process ingredients that provide ingredients with a degree of isolation of the encapsulate from the product matrix. Encapsulation components are utilized to encapsulate product components in the series process to provide a degree of isolation from the ambient environment. The use of these components and processes, which provide a degree of isolation, offers benefits of, in part, migration of volatiles, isolation of microbial activity and the decomposition of beneficial microbes, separation of chemically reactive or interactive components, and isolation of environmental components such as, in part, moisture, oxygen, halogens, microbes, solvents, and reactive materials.

9. Real-time analyses of chemical and nutritional composition to control in-situ processes and component additions.

Preferably, real-time chemical analysis of the feedstock and the partially treated material chemistry is performed and used to control the processing of chemical compositions leading to the final product. In addition, several support processes also take place independently of the waste treatment process, such as preparation of the chemical reactants, solutions, admixtures, and encapsulations used in the treatment process, and packaging of the final product. These support processes can also benefit from real-time chemical analysis and control.

Whether real-time chemical analysis is performed or not, the process of the invention preferably utilizes overall process control means, preferably digital computer based, capable of inputting a database of feed data points that represent the composition of a particular feedstock. Using the database information, computational means contained within the overall process control means carry out algorithms based on a set of target data points representing the desired compositions of the final product(s) and the chemical reactants used in the process and determine the necessary quantities of reactants to be added to the feedstock as it passes through the process to achieve the desired final product composition(s). A preferred computational means is embodied in spreadsheet software run on a digital computer, programmable logic controller, or equivalent equipment. The spreadsheet can be permanently programmed with multiple sets of target data points and reactant data points (since these values are independent of feedstock composition and are relatively constant), or they can be input from the database along with the feed data points. The calculation results from the computational means are converted into signals representing desired control parameters (e.g. flow, temperature and level set points, total quantity of a particular reactant added, etc.) and the signals are sent to conventional automated process control equipment. The overall process control means directs the series process reactions and the tangential processes for ingredient adds preparation as shown in FIG. 1A-1B. Preferably, real time chemical analysis is also performed on important process and reactant preparation streams, and these measurements are converted into data used by the overall process control means as an additional feedback control to ensure desired finished product compositions and narrow batch-to-batch variations. The control scheme just described also polices process variations and guides the process to follow a prescribed process design path. Data being provided to the computational means can and preferably will include data of ambient conditions and process conditions. The control scheme can be configured to allow for variations in such factors as extents of chemical reactivates, fugacity caused by volatilization and component losses, identifying yields and yield efficiencies during processing, and other factors. The flexibility of the overall process control means is more than a desirable feature. Biological waste feeds will vary drastically, even from batch to batch supplied from the same source, much less the variations between difference waste sources, and the control means needs to be extremely flexible to handle these variations. For example, the form of biological waste known as ‘chicken litter’ generally comprises chicken manure, but also regularly contains feathers, dust, nest material, and even parts of dead chickens. Depending on the cages of a chicken farm are cleaned on a particular day, the chicken manure may comprise the major component of the chicken litter, or be only a small fraction of the total. Also, switching to a different waste feedstock can result in changes not only of the amounts of reactants used, but even of what reactants are added and at what times. For example, horse manure is significantly higher in nitrogen content than most other manures. In some cases, the nitrogen level can be so high that, rather than adding nitrogen supplements for nutritional balance, one particular process component of the invention process might be a step for removing nitrogen from the processed feedstock in order to achieve the target nitrogen level. Therefore, given the various and numerous products and feedstocks previously discussed, a comprehensive discussion of the potential configurations and process components that make up the process of the invention would be beyond the scope of this specification. However, for any given feedstock(s) and desired final product(s), a person of ordinary skill in the art can determine the necessary process configuration and other parameters to practice the process of the invention.

10. Incorporating desired specific grass or plant seeds into product particles.

Desired grass and plant seeds can be incorporated into finished products so that when the product is applied to the ground, seeds are planted and fertilized with the proper balance of nutrition for germination and growth for the specific incorporated seeds. Various seeds can be utilized—smaller seed sizes are most compatible for incorporating into a wider range of product configurations. Smaller seeds can be incorporated into the matrix of physically formed products when the products are manufactured from raw waste stock as compared to previously physically produced forms, however, the embodiments describe means to bind and cleave small seeds onto the surfaces of various previously formed products. The smaller neat seeds are classically more difficult to apply uniformly onto the ground due to effects of mechanical seeders' variations of application, types of seeders, wind effects, seed migration due to water floatation and migration of seeds, as well as other factors. Larger seeds can be utilized in products as long as the products are of an adequate size to allow incorporation of the larger seeds—products that would provide adequate size would be, in part, prills, beads, pellets, powders, rigid poke sticks, rigid liquefied emulsion, poke sticks without plastic sheaths, liquefied emulsion without plastic sheaths, etc. having larger dimensions as compared to the seeds being designed for incorporation.

11. Moisture control during processing and final product manufacturing by chemical, thermal, or other means of drying.

Drying is accomplished by utilizing drying equipment and processes such as, in part, ambient air, blender, mixer, chemical, exothermic, thermal, and vacuum means, individually or in combination, as well as other means known in the art or that will become known in the art as substitutes. Ambient air-drying is generally utilized where appropriate low humidity air is exposed to the drying process material to enhance drying. Blender or mixer drying can be utilized to increase air exposure to the product. Chemical drying can be accomplished by dry chemical additions where the chemical hygroscopically extracts moisture from the product. Exothermic drying can be utilized when chemical reactivity in the product produces heat causing the temperature of the product to increase, which enhances drying. Exothermic drying can also be utilized where there are mechanical frictional effects causing an increase in temperature of the product during processing. Thermal drying is accomplished when heat is applied to the process product causing the temperature to increase. Vacuum drying is utilized when the pressure is decreased on a mixer or blender causing an increase in the evaporation rate of water. These means above are governed by Raoult's Laws of Partial Vapor Pressures.

12. Perform specialty ingredients and aesthetic component additions such as the adding and blending of beneficial microbials, product stabilizers, growth regulators, fragrances, flavors, colorants, encapsulates in product, and other beneficial ingredients in the product.

The optional beneficial microbial agents are used in forms including, in part, solutions, dispersions and emulsions, dry particulates, and encapsulations. The microbial agents are used for plant root activation, increasing soil nutrient uptake rate by plants, enhancing additive availability of plants, reactivating soil by metabolizing oils, chemicals, herbicides, pesticides, or other chemicals that have poisoned or sterilized either the soil or the feedstock waste materials being processed for plant and seed growth, and for producing a nutritional product with improved nitrogen and nutritional activity. The microbial agents are optionally used for enhanced digestion of the animal feed products as well as other beneficial properties. Addition of aesthetic components such as fragrances, flavors, colorants, and other beneficial ingredients to compliment the final product and its product enhancement are also facilitated by the embodiments.

13. Packaging.

Proper packaging needs to compliment the final product and its product stability and storage specifications. Products that have certain requirements and tendencies after manufacturing and while in packaged form, such as, in part, being hygroscopic, sensitive to anaerobic and aerobic tendencies, sensitive to changes in moisture content, volatilization of components, and others, the proper choice of packaging materials and process is important. Products that need an isolation barrier for ambient conditions such as air, humidity, and other environmental factors that could deteriorate or decrease the life of the product, packaging materials need to afford such protection. Packaging may well need to be vapor semi-permeable or permeable to aid in protecting the life of the product. Proper choice of packaging materials are important for, in part, the life and effectiveness of seed germination, minimizing microbial digestion, maintaining integrity of encapsulated components and elements, support of the package weight and handling of the finished product.

Additional features and advantages of the invention will become apparent in the following detailed description and in the drawings.

### BRIEF DESCRIPTION OF THE DRAWINGS

FIG. 1A-1B is a flow chart of the various embodiments of a waste treatment process according to the invention.

### DETAILED DESCRIPTION OF THE EMBODIMENTS

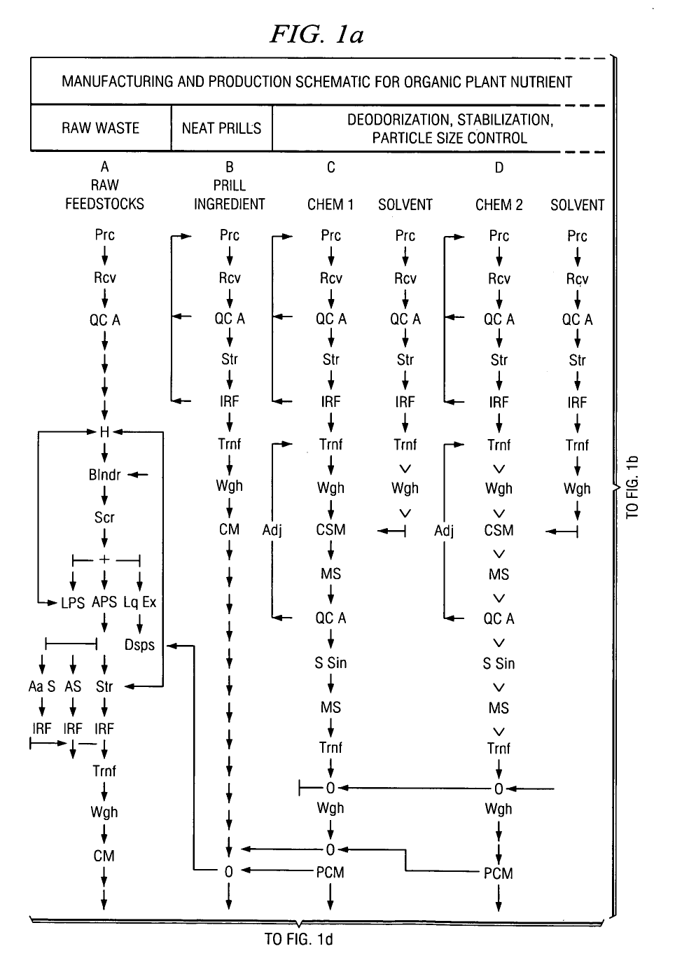

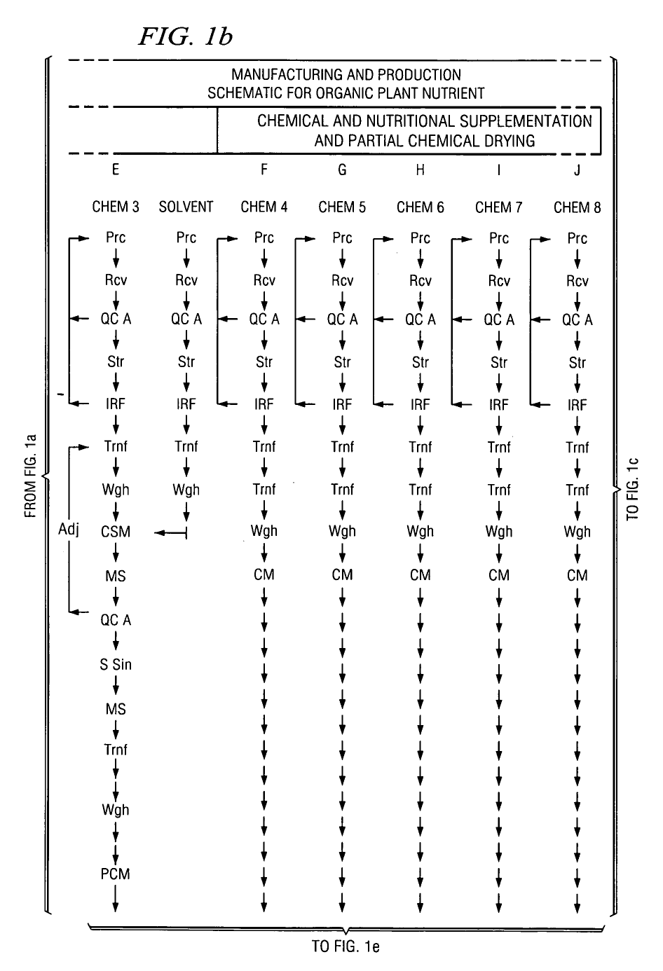

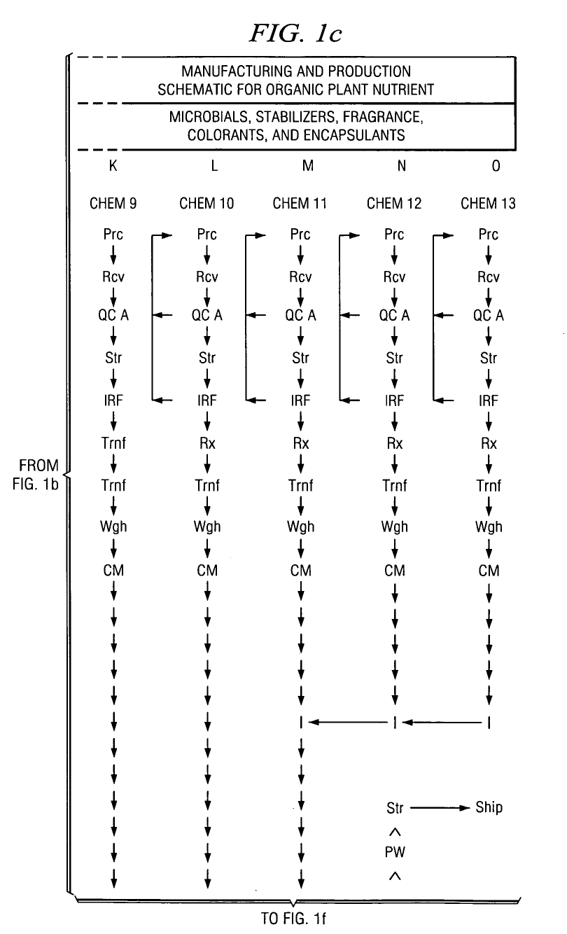

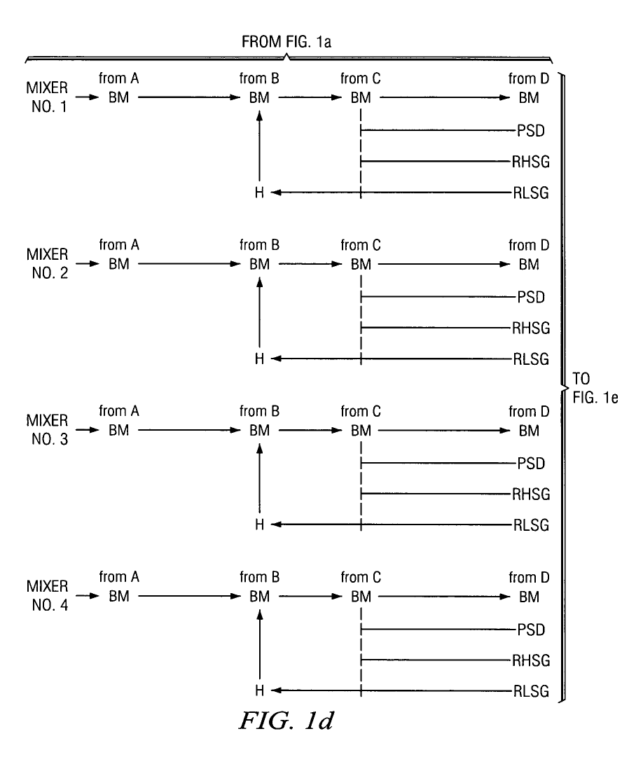

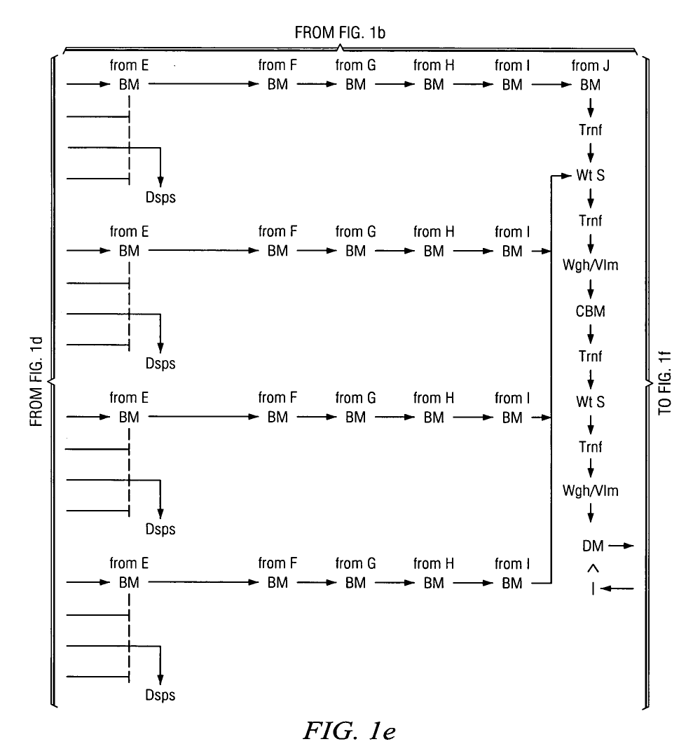

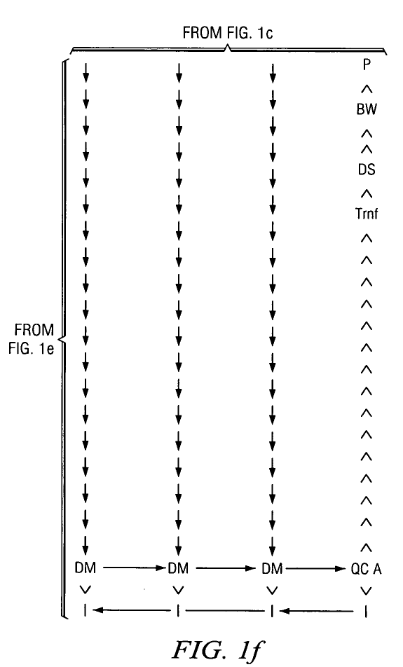

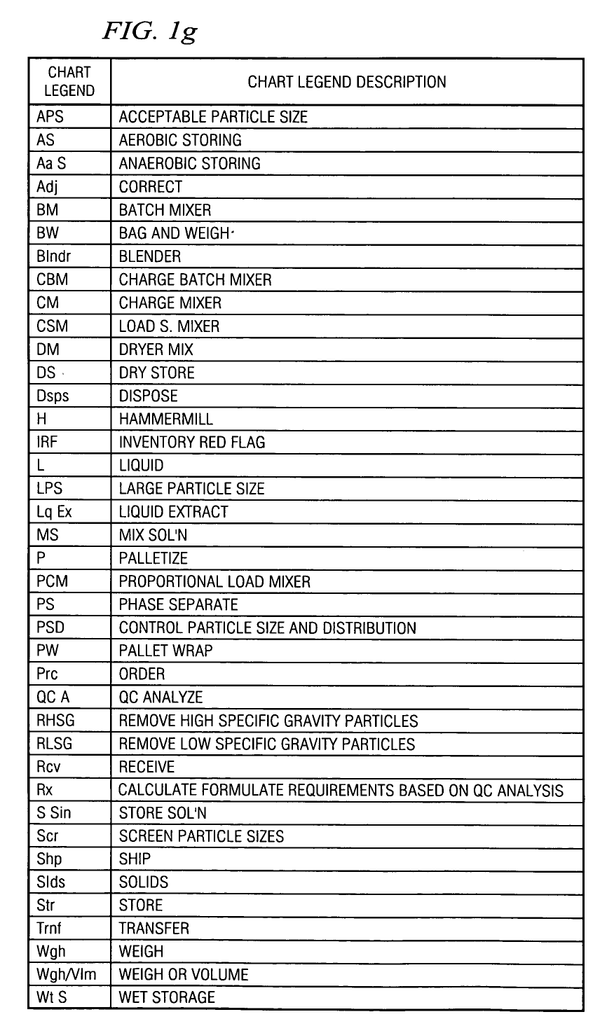

FIG. 1A-1B shows a comprehensive flow chart of the various possible embodiment of the waste treatment method of the invention. The overall method consists of several smaller process components, which can be interrelated as modules in a number of different ways. Some of the components (or groups of components) need to be arranged in sequence, while others can be performed in parallel and their respective products combined as part of other process components.

The major process components are categorized as follows:
(1) Grinding and hammer-milling;
(2) Blending and mixing;
(3) Odor reduction;
(4) Inactivation of undesirable grass, plant, or weed seeds;
(5) Sterilization and abatement of pathologic microbes and bactericidal treatment;
(6) Particle forming of prills, pellets, beads, powders, or various other physical forms;
(7) Preparation of component solutions, emulsions, dispersions, or chemical reaction products;
(8) Preparation of encapsulates and encapsulated components;
(9) Real-time analyses of chemical and nutritional composition;
(10) Incorporating desired specific grass or plant seeds into product;
(11) Moisture control;
(12) Perform specialty ingredients and aesthetic component additions; and
(13) Packaging.

The process components listed above are not sufficiently discussed previously in the specification will now be discussed in detail.

1. Grinding and hammer-milling.

It is desirable for the processing reactants to react as rapidly and completely as possible with the various beneficial and non-beneficial components in waste material and to provide finished products that are relatively homogeneous in composition. These goals can be achieved by fine particle exposure to the chemical reactants whereas the fine particles are created by hammer-milling the waste material and intermediate product prior to and in combination with chemical reactant exposures. Hammer-milling is a high mechanical shear force pulverizer and mixer. There is an inverse relationship between particle size and chemical reactivity whereby decreased particle size yields increased chemical reactivity. In many of the embodiments reactants, supplements, admixtures, reactant solutions, nutrients, and other required components of the invention could also added during hammer-milling.

2. Blending and mixing.

Reactants and additives can be mixed or blended with the various components with or without the waste material to provide finished products that are relatively homogeneous in composition. The embodiments utilize various mixers and blenders which include types such as, in part, tub, ribbon, tumbler, vacuum, pressure, heated, cooled, solution, pump, propeller, aeration, sparger, ball, sand mill, impingement, roller, high shear, and other mixers and blenders known in the art or that will become known in the art as substitutes or applicable mixers or blenders. Mixing and blending is also utilized to add reactants, supplements, admixtures, solutions, nutrients, and other required components of the embodiments.

3. Odor reduction.

Chemical treatment can be carried out for odor reduction by chemically modifying malodorous chemicals, decreasing vapor pressures of odoriferous components, encapsulating odoriferous chemicals, and eliminating certain bacterial pathogens that produce odoriferous chemicals for which these chemical treatment components are within the scope of the chemicals utilized for odor reduction. Traditionally, deodorization is largely accomplished by exposing waste material to a temperature greater than 90° C. for a predetermined time, drying moisture out of the product to very low levels, and additionally utilizing strong mineral acids and oxidative chemicals such as sulfuric acid and peroxides to chemically modify the odoriferous chemicals. This approach of deodorization is a destructive sledge hammer approach that thermally, pyrolytically, and chemically destroys inherent good nutrition and organic components in the waste material that would require replenishing it subsequently or result in an oxidized chemical “ash” with the loss of a large part of its organic character. As waste material and/or nutritional compounds such as ammonium and amines compounds are exposed to sledge hammer chemistry and processes, the compounds are oxidized to non-nutritional components (nitrates, NOx gases, sulfates, SOx gases, carbonates, COx gases), and ammonia and ammonium hydroxide will deteriorate and chemically strip off and vaporize due to temperature exposure of only 90° C.

This invention is based on essentially an opposite design philosophy calling for minimization of temperature, maintaining a modest level of moisture throughout the process, and utilizing redox reduction type Lewis Acids that are much less chemically reactive and which therefore do not chemically destroy the nutrient components in the waste material while still accomplishing the desired deodorization. For example, when the Lewis Acids react with ammonium compounds in the waste, the resultant reaction products are Lewis Acid product complexes and ionically bound chemical radicals where the ammonium chemical structure is available as a plant nutrient. The choice of chemical components for this task also is designed so that the desired nutritional balance and the desired properties of the finished products will be achieved. Many of the Lewis Acid reactants are themselves plant nutrients.

For odor reduction, suggested reactants include ammonia, oxygen, carbon dioxide, COx, ammonium salts, amine salts, ferrous compounds, organic chromium compounds, organic nickel compounds, organic selenium compounds, organic arsenic compounds, barium salts, sodium salts, lithium salts, metal and cationic proteinates, quaternary ammonium halides and anions, magnesium salts, calcium salts, manganese salts, cobalt salts, copper salts, zinc salts, sulfate compounds, SOx radicals, nitrate compounds, phosphate compounds, carbonate compounds, bicarbonates, sulfates, sulfonates, hydroxides, alums, mineral ores, zwitterions, copperases, chlorophyll, waxes, d-limonene, plant and seed oils, milled grains, celluloid particles and fibers, diatomaceous agents, crystalline silicas, dimeric carboxylic acids, dibasic alkylarylglycols, polybasic polymers, primary, secondary, and tertiary amine compounds, molasses, sorghums, carbohydrates, plant carbohydrates, and starches individually or in mixture or chemical reaction product combinations as well as other natural and organic chemical reactants known in the art or that will become known in the art as substitutes or applicable reactant components. Bactericidal agents, nutritional supplements, and chemicals that contribute to the finished products desired properties, such as mechanical strength, reduced dust formation, solubility in water, stability, and many other important attributes can include many of the above chemicals. The selection of chemical agents will depend upon the input waste material, intended use, size and shape of the product, as well as other desired factors.

4. Inactivation of undesirable grass, plant, or weed seeds.

Inactivation of seeds in the treated material is almost always required in plant nutrient products; however, animal feeds do not generally require inactivation of seeds. While thermal sterilization can be used to inactivate seeds, chemical reactants can also be used and are preferred. Chemical reactants that facilitate the inactivation of plant, grass, or weed seeds are those that increase the chemical digestion of the seeds, increased metabolism rates associated with seed inactivation, and chemical reactions with and solubilization of components within the seeds that are required for seed germination.

Chemical reactants that inactivate plant, grass, or weed seeds include, in part, a non-exhaustive list including ammonia, carbon dioxide, nitrogen, ammonium salts, amine salts, ferrous compounds, organic chromium compounds, organic nickel compounds, organic selenium compounds, organic arsenic compounds, barium salts, sodium salts, lithium salts, metal and cationic proteinates, quaternary ammonium halides and anions, magnesium salts, calcium salts, manganese salts, cobalt salts, copper salts, zinc salts, sulfate compounds, nitrate compounds, phosphate compounds, carbonate compounds, bicarbonates, sulfates, sulfonates, hydroxides, alums, mineral ores, zwitterions, copperases, chlorophyll, waxes, d-limonene, plant and seed oils, milled grains, celluloid particles and fibers, diatomaceous agents, crystalline silicas, dimeric carboxylic acids, dibasic alkylarylglycols, polybasic polymers, primary, secondary, and tertiary amine compounds, molasses, sorghums, carbohydrates, plant carbohydrates, starches, pectin, polyesters, polyarylcarboxylic acids, polyaliphatics, polyalkylcarboxylic acids, polyarylalkylglycols, aryl and alkyl dicarboxylic acids, terephthalic acids, succinic acid, adipic acid, 1,4-butanediol, ethylene glycol, propylene glycol, neopentyl glycol, gibberellins, cytokinins, kinins, dicocoamine, dimethylcocoamine, isoureas, isothioureas, lactams, auxins, brassins, triacontontanols, sideromycins, humic acids, humates, 1-aminocyclopropane-1-carboxylic acid; triazole and imidazole substituted compounds with ketones, alcohols, hydroxyketones, diketones, and diols; and quaternary ammonioalkane carboxylic acid anilides, polymeric quaternary ammonium compounds, alkyl/aryl quaternary ammonium compounds, oxopyrimidines, arylcarboxy pyridones, individually or in mixture or chemical reaction product combinations as well as other natural and organic chemical reactants known in the art or that will become known in the art as substitutes or applicable reactant components. Specific reactants known in the industry can also be used. Furthermore, additional reactants will likely be discovered from ongoing experimentation and research.

5. Sterilization and abatement of pathologic microbes and bactericidal treatment.

Waste material, especially animal waste, contains pathogenic bacterial, fungi, and microbial components. Chemical treatment can be carried out to eliminate these pathogens while establishing the desired nutritional balance, and to give the finished products the desired properties. Sterilization can be accomplished using minimum practical temperature applied for the shortest practical time, while utilizing aerobic thermophilic and exothermic sterilization as much as possible. As discussed above, alternatively, a sledge hammer approach can be utilized for sterilization. The embodiments generally utilize an approach for sterilization analogous to that previously described for deodorization in order to achieve adequate biostatic activity and minimal destructive impact on the nutrient chemistry and the certifiable as organic and natural inherent character of the waste.

The invention utilizes chemical reactants, minimizes moisture content in the process, and exposes the pathogenic components to salting effects where they are exposed to high devastating osmotic cell pressures due to salt exposure of Lewis Acids and other reactants. In addition, aerobic digestion (which produces heat and biostatic activity) and chemical and natural exothermic processes are utilized. For sterilization, the suggested reactants include ammonia, oxygen, carbon dioxide, COx, ammonium salts, amine salts, ferrous compounds, organic chromium compounds, organic nickel compounds, organic selenium compounds, organic arsenic compounds, barium salts, sodium salts, lithium salts, metal and cationic proteinates, quaternary ammonium halides and anions, magnesium salts, calcium salts, manganese salts, cobalt salts, copper salts, zinc salts, sulfate compounds, nitrate compounds, phosphate compounds, carbonate compounds, bicarbonates, sulfates, sulfonates, hydroxides, alums, mineral ores, zwitterions, copperases, chlorophyll, waxes, d-limonene, plant and seed oils, individually or in mixture or chemical reaction product combinations as well as other natural and organic chemical reactants known in the art or that will become known in the art as substitutes or applicable reactant components. Bactericidal agents, nutritional supplements, and chemicals that contribute to the finished products desired properties, such as mechanical strength, reduced dust formation, solubility in water, stability, and many other important attributes can include many of the above chemicals. The selection of chemical agents will depend upon the input waste material, intended use, size and shape of the product, as well as other desired factors.

Chemical treatment can be utilized separately and singularly or it can be utilized in combination with many elements of the process steps such as deodorization, sterilization, admixtures, growth regulators, encapsulates, and in-situ encapsulating process, particle sizing and control, fragrances, flavors, coloring, and many other process and treatment elements of the invention. The chemical treatment reactants can be solid, liquid or gas. A non-exhaustive list includes ammonia, oxygen, carbon dioxide, nitrogen, ammonium salts, amine salts, ferrous compounds, organic chromium compounds, organic nickel compounds, organic selenium compounds, organic arsenic compounds, barium salts, sodium salts, lithium salts, metal and cationic proteinates, quaternary ammonium halides and anions, magnesium salts, calcium salts, manganese salts, cobalt salts, copper salts, zinc salts, sulfate compounds, nitrate compounds, phosphate compounds, carbonate compounds, bicarbonate, sulfates, sulfonates, hydroxides, alums, mineral ores, zwitterions, copperases, chlorophyll, gibberellins, cytokinins, kinins, dicocoamine, dimethylcocoamine, isoureas, isothioureas, lactams, auxins, brassins, triacontontanols, sideromycins, humic acids, humates, 1-aminocyclopropane-1-carboxylic acid; triazole and imidazole substituted compounds with ketones, alcohols, hydroxyketones, diketones, and diols; and quaternary ammonioalkane carboxylic acid anilides, polymeric quaternary ammonium compounds, alkyl/aryl quaternary ammonium compounds, oxopyrimidines, arylcarboxy pyridones, molasses, sorghums, carbohydrates, plant carbohydrates, starches, individually or in mixture or chemical reaction product combinations as well as other natural and organic chemical reactants known in the art or that will become known in the art as substitutes or applicable reactant components.

The process can also employ thermal and chemical inactivation and beneficial microbial agents for the treatment of microbial pathogens. A non-exhaustive list of microbial strains that have proven useful, either alone or in combination of two or more types, are: Bacillus licheniformis, Bacillus subtilis, Bacillus lentimorbus, Bacillus thuringiensis canadensis, Brevundimonas vesicularis, Cellulomonas flavigena, Corynebacterium ammoniagenes, Pseudomonas aeruginosa, Rhodoccus chubuensis, Actinomycete, Clostridium pectinovorum, and those known in the art or that will become known in the art as substitutes or applicable microbial agents and microbial applications.

6. Particle forming of prills, pellets, beads, powders, or various other physical forms.

Product size and controlled size distribution range from fine powder, e.g. micron particle diameter, to large ball or particle sizes greater than 2.5 cm (1 inch) in diameter, depending on the intended use. For example, if a product is intended for use as a grass fertilizer or nutrient where a mechanical spreader is to apply the product, the relatively standardized gate openings and broadcast means used on mechanical spreaders demand a specific uniform particle size. It is preferred in the trade for the particle size to be uniform, however, seldom is it uniform. Size uniformity minimizes variation in broadcast dosage rates and more importantly minimizes particle dust generation, which is a nuisance and an environmental and possible health hazard.

During processing, fine particles being produced by hammer-milling can be enlarged uniformly by adding chemical additives in solution and solid form. These chemicals enlarge the particles through agglomeration, association, wetting, adherence, and ionic attraction via anionic and cationic components, polar components, and components with varying solubility and ionic character on a given reactant component. The degree of enlargement can also be adjusted by controlling the rate of component addition, especially for aqueous solutions. Generally, it is observed that high rates of solution additions yield large particle sizes and reciprocal rates yield small particle sizes. Large particle sizes can be amplified further by adding dry fine particle stock or chemical components. Particle size distribution is controlled by proper addition rates of components, types of components, liquid and water content, mixer type, speed of mixer, and by applying the material so that it impinges on the near null movement point in the mixer. This last factor is especially applicable for tub mixers. Particle sizing can also be accomplished by prilling, pellitizing, beading, and other mechanical means known in the art. These products can be further developed and improved by blending with other particle formed products to create larger products having more uniformity of particle size. The components identified above and proper mixer and blender design achieve sizing and control of particle size.

7. Preparation of component solutions, emulsions, dispersions, or chemical reaction products.

Component solutions, emulsions, dispersions, chemical reaction products utilized in this invention are prepared with an emphasis of maximum effective concentrations and minimum water and volatile concentrations. End use and applications forms that utilize rigid forms, such as poke sticks or liquefied emulsion, will benefit from products created by component solutions, emulsions, dispersions, and chemical reaction products that are high solids and providing physical integrity to the produced form. Other application forms, such as liquids, emulsions, dispersions, and gels, the processed components are designed to contribute to these application forms. Solutions are designed to allow solubility of solutes down to lower limits of temperature. Emulsions and dispersions are designed to maintain stable laticies and micelliae structures. Chemical reaction products that are tangential additions to the process where chemical reactions are conducted separate of the series product process and are designed to produce reaction products with minimum residual reactants. The chemical reaction products are designed to have minimum carrier solvent, such as water when added to the product process.

Chemical treatment components utilized specifically for creating liquefied emulsions are, in part, ammonia, oxygen, carbon dioxide, nitrogen, ammonium salts, amine salts, ferrous compounds, ferric compounds, barium salts, potassium salts, sodium salts, lithium salts, metal and cationic proteinates, quaternary ammonium halides and anions, magnesium salts, calcium salts, sulfate compounds, phosphate compounds, carbonate compounds, cationic bicarbonates, sulfates, sulfites, sulfonates, hydroxides, alums, mineral ores, zwitterions, copperases, chlorophyll, waxes, d-limonene, plant oils, seed oils, animal oils, pectin, thixotropes, whey solids, diatomaceous agents, milled grains, celluloid particles and fibers, crystalline silicas, dimeric carboxylic acids, dibasic alkylarylglycols, polybasic polymers, primary amine compounds, secondary amine compounds, tertiary amine compounds, polyalkylaryloxiranes, barites, non-newtonian agents, polyesters, polyarylcarboxylic acids, polyaliphatics, polyalkylcarboxylic acids, polyarylalkylglycols, aryl and alkyl dicarboxylic acids, terephthalic acids, succinic acid, adipic acid, 1,4-butanediol, ethylene glycol, propylene glycol, neopentyl glycol, isoureas, isothioureas, lactams, triacontontanols, alkanol, humic acids, humates, polymeric quaternary ammonium compounds, alkyl/aryl quaternary ammonium compounds, molasses, sorghums, carbohydrates, plant carbohydrates, starches, individually or in mixture or chemical reaction product combinations as well as other natural and organic chemical reactants known in the art or that will become known in the art as substitutes or applicable reactant components.

Depending on the viscosity and other product parameters to be produced by the invention, certain chemical components are utilized in varying physical processing means. Generally, as the specific chemical components are chosen for composition and product parameters, the process utilizes high shear dispersing equipment to establish two forms of dispersions being either an oil-in-water or water-in-oil dispersion.

The former part of the type of dispersion identifies the discontinuous phase of the dispersion and the latter part identifies the continuous phase. The terms “oil” used is defined in these matters to mean non-water soluble components and “water” is defined as the water-soluble components. The resultant dispersion is opaque and viscous requiring coalescing agents to aid the fusing process of the product as the water and other volatiles evaporates. Oil-in-water dispersions are more readily available for plant uptake and soil imbuement than are water-in-oil dispersions. Oil-in-water dispersions are faster drying than the other form. Water-in-oil dispersions are more readily adsorbed by plant foliage than the other form. The chemical interaction property that primarily governs these matters is surface tension. Oils, plant leaves, etc. are low in surface tension, so oil wets leaves more completely and has greater intimate contact. Water, soils, etc. are high in surface tension, so water wets soils more completely and has greater intimate contact. Water and water-soluble components have higher plant uptake rates than do oils.

Dispersions are generally prepared by using high shear processing to first create a homogeneous continuous phase composition, then secondly, the discontinuous phase material is prepared separately by mixing to be homogeneous in composition, then thirdly, the discontinuous composition material is slowly added to the continuous phase composition material during high shear.

8. Preparation of encapsulates and encapsulated components.

Encapsulates and encapsulation components are process ingredients that provide ingredients with a degree of isolation of the encapsulate from the product matrix. Encapsulation components are utilized to encapsulate product components in the series process to provide a degree of isolation from the ambient environment. The use of these components and processes, which provide a degree of isolation, offers benefits of, in part, migration of volatiles, isolation of microbial activity and the decomposition of beneficial microbes, separation of chemically reactive or interactive components, and isolation of environmental components such as, in part, moisture, oxygen, halogens, microbes, solvents, and reactive materials.

9. Real-time analyses of chemical and nutritional composition to control in-situ processes and component additions.

Nutritionally balancing the finished product is accomplished by adding beneficial components to the feedstock to provide a desired nutritional balance for specific plants and animals, depending on the intended use of the final product. Real-time analyses of the feedstock identifies the types and amounts of the nutritional components that should be prepared in parallel to the feedstock processing and are in solutions, emulsifications, dispersions, and/or neat component forms. Their proper additions are based on the real-time analyses of the feedstock and the target composition of the finished products. These beneficial nutritional components typically include cobalt salts, copper salts, magnesium salts, manganese salts, mineral ores, nitrogen, organic arsenates, organic chromium compounds, organic nickel compounds, organic selenium compounds, zinc salts, ammonia, ammonium salts, copperases, ferrous compounds, nitrates, phosphates, sulfates, sulfonates, sulfur, molasses, sorghums, carbohydrates, plant carbohydrates, starches, as well as other natural and organic nutrients known in the art or that will become known in the art as substitutes or applicable nutrient components. Analysis of the treated material following addition of the reactants is strongly preferred to ensure that the proper amounts of additives are used for a particular feedstock.

10. Incorporating desired specific grass or plant seeds into product.

The invention provides means for incorporating desired grass and plant seeds into finished products so that when the product is applied to the ground, seeds are planted and fertilized with the proper balance of nutrition for germination and growth for the specific incorporated seeds.

Various seeds can be utilized—smaller seed sizes are most compatible for incorporating into a wider range of product configurations. Smaller seeds can be incorporated into the matrix of physically formed products when the products are manufactured from raw waste stock as compared to previously physically produced forms, however, the embodiments describe means to bind and cleave small seeds onto the surfaces of various previously formed products. The smaller neat seeds are classically more difficult to apply uniformly onto the ground due to effects of mechanical seeders' variations of application, types of seeders, wind effects, seed migration due to water floatation and migration of seeds, as well as other factors. Larger seeds can be utilized in products as long as the products are of an adequate size to allow incorporation of the larger seeds—products that would provide adequate size would be, in part, prills, beads, pellets, powders, rigid poke sticks, rigid liquefied emulsion, poke sticks without plastic sheaths, liquefied emulsion without plastic sheaths, etc. having larger dimensions as compared to the seeds being designed for incorporation.

11. Moisture control.

The method of the invention achieves moisture and volatile component rarefaction without the use of high temperatures. Solutions prepared in the invention are designed to maximize concentration of reactants so as to minimize water being introduced to the product, which would subsequently need to be removed, yet still provide adequate chemical exposure, activity, mobility, and homogeneous blending of the reactants with the process feedstock. Reaction components and other components in solution are applied as far forward in the processing as possible, with solid reactants and dry components being added as early in the processing as possible. Chemical drying of the moisture can then occur because of the hygroscopic characteristics of the dry component additions. This chemical drying is achieved at ambient temperature and process material temperatures without having to apply external heat and elevate the product temperature. Also, introducing as much solution adds as possible early in the process allows the water being introduced to have longer exposure time while in mixers and blenders, allowing it to volatilize naturally and normally according to Raoult's Laws of Partial Vapor Pressures over a mixture. Additionally, the process of adding solid reactants to moisture-laden product is often exothermic in nature and will provide heat to the processed product, which in turn accelerates drying. Also, blender drying exposes the particulate product to ambient air and sub-ambient vacuum conditions to aid drying at low temperature. Air temperatures, humidity levels, and process serial speed of the process influence the additional use of drying means other than means at ambient conditions. Drying means to be utilized for drying and dry processing utilizing mixers and blenders are identified above individually, in part, or in mixture or chemical reaction product combinations as well as other means known in the art or that will become known in the art as substitutes.

Drying is accomplished by utilizing drying equipment and processes such as, in part, ambient air, blender, mixer, chemical, exothermic, thermal, and vacuum means, individually or in combination, as well as other means known in the art or that will become known in the art as substitutes. Ambient air-drying is generally utilized where appropriate low humidity air is exposed to the drying process material to enhance drying. Blender or mixer drying can be utilized to increase air exposure to the product. Chemical drying can be accomplished by dry chemical additions where the chemical hygroscopically extracts moisture from the product. Exothermic drying can be utilized when chemical reactivity in the product produces heat causing the temperature of the product to increase, which enhances drying. Exothermic drying can also be utilized where there are mechanical frictional effects causing an increase in temperature of the product during processing. Thermal drying is accomplished when heat is applied to the process product causing the temperature to increase. Vacuum drying is utilized when the pressure is decreased on a mixer or blender causing an increase in the evaporation rate of water. These means above are governed by Raoult's Laws of Partial Vapor Pressures.

12. Perform specialty ingredients and aesthetic component additions.

Growth regulators such as gibberellins, cytokinins, kinins, dicocoamine, dimethylcocoamine, isoureas, isothioureas, lactams, auxins, brassins, triacontontanols, sideromycins, humic acids, humates, 1-aminocyclopropane-1-carboxylic acid; triazole and imidazole substituted compounds with ketones, alcohols, hydroxyketones, diketones, and diols; and quaternary ammonioalkane carboxylic acid anilides, polymeric quaternary ammonium compounds, alkyl/aryl quaternary ammonium compounds, oxopyrimidines, arylcarboxy pyridones are applied individually, in part, or in mixture or chemical reaction product combinations as well as with other natural and organic chemical reactants known in the art or that will become known in the art as substitutes or applicable reactant components.

Optional beneficial microbial agents are used in forms, which include solution dispersions, emulsions, and dry particulate, and can be encapsulated for end-use performance that includes plant root activation, increased soil nutrient uptake rate by plants, and enhancing additive availability. Suitable microbial strains include in part: Bacillus licheniformis, Bacillus subtilis, Bacillus lentimorbus, Bacillus thuringiensis anadensis, Brevundimonas vesicularis, Cellulomonas flavigena, Corynebacterium ammoniagenes, Pseudomonas aeruginosa, Rhodoccus chubuensis, Actinomycete, and Clostridium pectinovorum, as well as other microbial strains known in the art or that will become known in the art as substitutes or applicable strains. Preferable microbial agent application concentration or dosage is about 1.70×10⁶ microorganism colonies (MC) per m² (1.58×10⁵ MC per ft²), or 1.70×10² MC per cm² (1.10×10³ MC per in²).

Growth regulators to accelerate plant growth and phytoenergetics are supplemented by components such as 1-aminocyclopropane-1-carboxylic acid, arylcarboxy pyridones, auxins, brassins, cationic proteinates, cytokinins, dicocoamine, dimethylcocoamine, dimethylcocoamine, gibberellins, humates, humic acids, imidazole alcohols, imidazole diketones, imidazole diols, imidazole hydroxyketones, imidazole ketones, isothioureas, isoureas, kinins, lactams, metal proteinates, oxopyrimidines, sideromycins, triacontontanols, triazole alcohols, triazole diketones, triazole diols, triazole hydroxyketones, and triazole ketones, as well as other natural and organic growth regulators known in the art or that will become known in the art as substitutes or applicable growth regulator components.

13. Packaging.

Proper packaging needs to compliment the final product and its product stability and storage specifications. Products that have certain requirements and tendencies after manufacturing and while in packaged form, such as, in part, being hygroscopic, sensitive to anaerobic and aerobic tendencies, sensitive to changes in moisture content, volatilization of components, and others, the proper choice of packaging materials and process is important. Products that need an isolation barrier for ambient conditions such as air, humidity, and other environmental factors that could deteriorate or decrease the life of the product, packaging materials need to afford such protection. Packaging may well need to be vapor semi-permeable or permeable to aid in protecting the life of the product. Proper choice of packaging materials are important for, in part, the life and effectiveness of seed germination, minimizing microbial digestion, maintaining integrity of encapsulated components and elements, support of the package weight and handling of the finished product.

Having described each of the process components in detail, the overall process can now be better understood by reference to the drawings. Initial reference is made to FIG. 1A-1B, which shows an embodiment of the waste treatment method of the invention. The overall method consists of several smaller process components, which can be interrelated as modules in a number of different ways. Some of the components (or groups of components) are arranged in sequence, while others can be performed in parallel and their respective products combined as part of the other process components as discussed above.

As shown in FIG. 1A-1B, the feedstock is first preferably treated to reduce odor by contacting the feedstock with a reactant comprising oxygen, quaternary ammonium anions, quaternary ammonium halides, sodium salts, zwitterions, ammonia, ammonium salts, copperases, ferrous compounds, nitrates, phosphates, sulfates, sulfonates, and sulfur, as well as other natural and organic chemical reactants known in the art or that will become known in the art as substitutes or applicable reactant components. The reactants are preferably prepared in solution, emulsification, dispersion or neat form separately from the feedstock; after preparation the deodorant components are added in a timely order of addition sequence while being continuously mixed with the feedstock when in solid, moist, or liquid form.

Following the addition of the nutritionally balanced products, the partially treated material is further treated with chemical reactants for additional deodorization, as bactericidal treatment, for further nutritional balancing, and to promote the desired product properties.

Although not illustrated in FIG. 1A-1B, thermal sterilization can optionally be used to kill pathogenic microbes in the feedstock and as a means to inactivate grass and weed seeds. Suitable temperature and length of time ranges will depend on the type of grass and weed seeds to be inactivated. Sufficient time should be taken to ensure that the temperature is achieved throughout the material to ensure complete sterilization, not just on the outer surface of the treated material. Therefore, monitoring the temperature of the core of the treated material is preferred, although not necessary if the residence time in the process is long enough to ensure thorough heating.

Hammer-milling is performed to reduce the partially treated material to a small, fairly uniform size prior to forming and chemically treating the finished product. Hammer-milling also increases the effective surface area of the treated material, which generally promotes more thorough treatment of the plant nutrient and animal feed by the chemical and microbial agents. Other mechanical processes such as agitated and non-agitated screening can be used in addition to hammer-milling when the particular feedstock properties permit.

As can be seen in FIG. 1A-1B, the same types of steps can be carried out at more than one location. For example, chemical treatment for deodorization, elimination of bacteria, and nutrient addition are repeated prior to and following hammer-milling. Mixing and blending can also be conducted at any point along the process.

At some point after hammer-milling, the treated material is sized and formed into the final product, such as blocks, cubes, prills, beads, pellets, and powder. The particular form will of course depend on the intended use of the product. Finally, additional chemical treatment as previously discussed can be performed on the sized and formed product and the product can be packaged in a suitable container.

In addition to the steps already mentioned, the treated material can optionally be encapsulated for certain products. Encapsulation is usually desirable when insolubility in water, slow release of nutrients, or elimination of dusting is preferred. Encapsulation is generally performed after final forming of the product, but can also be performed during treatment before or after hammer-milling.

While prepared chemical reactants can be purchased, the desired chemical reactants can also be prepared from basic compounds that are readily available commercially. In this case, a separate reactant production mixing process is also carried out independently of the treatment process as shown in FIG. 1A-1B.

An embodiment limited to production of prilled plant nutrients has been developed and partially tested. The major process components are a subset of the general process components and can be categorized as follows: 1) preparation of chemical adds, solutions, emulsions, and dispersions, 2) mixing and blending, 3) chemical treatment, 4) deodorization, 5) chemically balance of final product, 6) sizing and controlling particle size distribution, and shaping of the final product, 7) moisture control by chemical, ambient air, and thermal drying, 8) addition of fragrances and flavors, and 9) packaging. Some of the process components, such as mixing, chemical treatment, chemically balance product, particle size control, and moisture control can be performed at multiple locations in the overall process. For the sake of brevity, only significant differences between these components and the general process components previously discussed will be described in detail.

The general philosophy for odor reduction is the same as previously discussed. However, for this embodiment the particular reactants include oxygen, carbon dioxide, ammonium salts, amine salts, ferrous compounds, barium salts, sodium salts, metal and cationic proteinates, magnesium salts, calcium salts, copper salts, zinc salts, sulfate compounds, nitrate compounds, phosphate compounds, carbonate compounds, bicarbonates, sulfates, sulfonates, hydroxides, alums, mineral ores, and copperases, individually or in mixture or chemical reaction product combinations, as well as other natural and organic chemical reactants known in the art or that will become known in the art as substitutes.

Preparation of chemical adds, solutions, emulsions, and dispersions are accomplished by utilizing mixing and blending equipment and methods previously discussed. The chemical add can be liquid or dry in single or multiple component composition with or without solvents. Dry chemical adds need to be rendered to have small particle sizes to maximize their chemical exposure to the prilled waste stock. Decreasing the particle size of the chemical components can be accomplished by pulverizing and hammer-milling. Chemical solutions, emulsions, and dispersions are prepared in part by rendering dry ingredient components to have small particle size, which will maximize their surface area exposure to solvents, and result in more complete solubilization. Solvents, which can include water in the chemical solutions, emulsions, and dispersions, are prepared in such a fashion as to minimize the volatile portion and maximize the concentration of chemical components. This will generally increase chemical activity and decrease demands on moisture rarefaction latter in the process. Solutions, emulsions, and dispersions need to be added as far forward in the process as applicably possible to enhance time of exposure for chemicals to react and increased time to allow for removal of the volatile components with minimum energy requirements for drying.

Chemical treatment, for this particular embodiment, is carried out for odor reduction by chemically modifying odoriferous chemicals and decreasing vapor pressures of odoriferous components for which these chemical treatment components are within the scope of the chemicals utilized for odor reduction and plant nutritional performance. Traditionally, deodorization is largely accomplished by exposing waste material to a temperature greater than 90° C. for a predetermined time, drying moisture out of the product to very low levels, and additionally utilizing strong mineral acids and oxidative chemicals such as sulfuric acid and peroxides to chemically modify the odoriferous chemicals. This approach of deodorization is a destructive sledge hammer approach that thermally, pyrolytically, and chemically destroys inherent good nutrition and organic components in the waste material that would require replenishing it subsequently or result in an oxidized chemical “ash” with the loss of a large part of its organic character. As waste material and/or nutritional compounds such as ammonium and amines compounds are exposed to sledge hammer chemistry and processes, the compounds are oxidized to non-nutritional components (nitrates, NOx gases, sulfates, SOx gases, carbonates, COx gases), and ammonia and ammonium hydroxide will deteriorate and chemically strip off and vaporize due to temperature exposure of only 90° C. This invention is based on essentially an opposite design philosophy calling for minimization of temperature, maintaining a modest level of moisture throughout the process, and utilizing redox reduction type Lewis Acids that are much less chemically reactive and which therefore do not chemically destroy the nutrient components in the waste material while still accomplishing the desired deodorization. For example, when the Lewis Acids react with ammonium compounds in the waste, the resultant reaction products are Lewis Acid product complexes and ionically bound chemical radicals where the ammonium chemical structure is available as a plant nutrient. The choice of chemical components for this task also is designed so that the desired nutritional balance and the desired properties of the finished products will be achieved. Many of the Lewis Acid reactants are themselves plant nutrients. For odor reduction, suggested reactants include oxygen, carbon dioxide, ammonium salts, amine salts, ferrous compounds, barium salts, sodium salts, metal and cationic proteinates, magnesium salts, calcium salts, copper salts, zinc salts, sulfate compounds, nitrate compounds, phosphate compounds, carbonate compounds, bicarbonates, sulfates, sulfonates, hydroxides, alums, mineral ores, copperases, individually or in mixture or chemical reaction product combinations as well as other natural and organic chemical reactants known in the art or that will become known in the art as substitutes or applicable reactant components. Nutritional supplements and chemicals that contribute to the finished product's desired properties, such as mechanical strength, reduced dust formation, solubility control in water, stability, and many other important attributes can include many of the above chemicals. The selection of chemical agents will depend upon the input waste material, intended use, size and shape of the product, as well as other desired factors.

Chemical treatment, for this particular embodiment, can be utilized separately and singularly or it can be utilized in combination with many elements of the process steps such as deodorization, admixtures, particle sizing and control, fragrances, flavors, coloring, and many other process and treatment elements of the invention. The chemical treatment reactants can be solid or liquid. A non-exhaustive list includes oxygen, carbon dioxide, ammonium salts, amine salts, ferrous compounds, barium salts, sodium salts, metal and cationic proteinates, magnesium salts, calcium salts, copper salts, zinc salts, sulfate compounds, nitrate compounds, phosphate compounds, carbonate compounds, bicarbonate, sulfates, sulfonates, hydroxides, alums, mineral ores, copperases, individually or in mixture or chemical reaction product combinations as well as other natural and organic chemical reactants known in the art or that will become known in the art as substitutes or applicable reactant components.

Chemical treatment, for this particular embodiment, for balancing composition of product is accomplished by identifying the desired qualitative and quantitative chemical compositional values needed in the final product in the prilled waste stock being utilized. The difference between the required final product composition and the waste stock is determined which is thusly provided to the product by proper choice of those ingredients and amounts of chemicals utilized in the process. These beneficial nutritional components typically include cobalt salts, copper salts, magnesium salts, manganese salts, mineral ores, nitrogen, organic arsenates, organic chromium compounds, organic nickel compounds, organic selenium compounds, zinc salts, ammonia, ammonium salts, copperases, ferrous compounds, nitrates, phosphates, sulfates, sulfonates, and sulfur, as well as other natural and organic nutrients known in the art or that will become known in the art as substitutes or applicable nutrient components. Analysis of the treated material following addition of the reactants is strongly preferred to ensure that the proper amounts of additives are used for a particular feedstock.

Product size and controlled size distribution, for this particular embodiment, range from fine powder, e.g. micron particle diameter, to large ball or particle sizes greater than 2.5 cm (1 inch) in diameter, depending on the intended use. For example, if a product is intended for use as a grass plant nutrient or nutrient where a mechanical spreader is to apply the product, the relatively standardized gate openings and broadcast means used on mechanical spreaders demand a specific uniform particle size. It is preferred in the trade for the particle size to be uniform, however, seldom is it uniform. Size uniformity minimizes variation in broadcast dosage rates and more importantly minimizes particle dust generation, which is a nuisance and an environmental and possible health hazard. During processing, fine particles being produced by hammer-milling can be enlarged uniformly by adding chemical additives in solution and solid form. These chemicals enlarge the particles through agglomeration, association, wetting, adherence, and ionic attraction via anionic and cationic components, polar components, and components with varying solubility and ionic character on a given reactant component. The degree of enlargement can also be adjusted by controlling the rate of component addition, especially for aqueous solutions. Generally, it is observed that high rates of solution additions yield large particle sizes and reciprocal rates yield small particle sizes. Large particle sizes can be amplified further by adding dry fine particle stock or chemical components. Particle size distribution is controlled by proper addition rates of components, types of components, liquid and water content, mixer type, speed of mixer, and by applying the material so that it impinges on the near null movement point in the mixer. This last factor is especially applicable for tub mixers. Particle sizing is also accomplished by prilling, pellitizing, beading, and other mechanical means known in the art. These products can be further developed and improved by blending with other particle formed products to create larger products having more uniformity of particle size. The components identified above and proper mixer and blender design achieve sizing and control of particle size.

The particular embodiment provides for moisture and volatile component rarefaction without the use of high temperatures. Solutions prepared in the invention are designed to maximize concentration of reactants so as to minimize water being introduced to the product, which would subsequently need to be removed, yet still provide adequate chemical exposure, activity, mobility, and homogeneous blending of the reactants with the process feedstock. Reaction components and other components in solution are applied as far forward in the processing as possible, with solid reactants and dry components being added as early in the processing as possible. Chemical drying of the moisture can then occur because of the hygroscopic characteristics of the dry component additions. This chemical drying is achieved at ambient temperature and process material temperatures without having to apply external heat and elevate the product temperature. Also, introducing as much solution adds as possible early in the process allows the water being introduced to have longer exposure time while in mixers and blenders, allowing it to volatilize naturally and normally according to Raoult's Laws of Partial Vapor Pressures over a mixture. Additionally, the process of adding solid reactants to moisture laden product is often exothermic in nature and will provide heat to the processed product which in turn accelerates drying. Also, blender drying exposes the particulate product to ambient air and sub-ambient vacuum conditions to aid drying at low temperature. Air temperatures, humidity levels, and process serial speed of the process influence the additional use of drying means other than means at ambient conditions. Drying means to be utilized for drying and dry processing utilizing mixers and blenders are identified above individually, in part, or in mixture or chemical reaction product combinations as well as other means known in the art or that will become known in the art as substitutes.

Addition of fragrance and flavors to this particular embodied product provides aesthetic benefits. Generally, the product has a pleasant slight mineral type odor when produced by this invention. To provide additional benefits for the scent of the product, fragrances and flavors, can be added in the final stages of mixing.

Packaging of the finished product can be accomplished in many different forms, however, the most common format would be in plastic bags capable of heat sealing tops. A exemplary table of relevant element concentration for the composition is shown in TABLE 1.

| | Form | | | | | |
|---|---|---|---|---|---|---|
| | Prilled | | Prilled | | Prilled | |
| | Use | | | | | |
| | General | | General | | General | |
| | Plant | | Plant | | Plant | |
| | Nutrient | | Nutrient | | Nutrient | |
| | Waste Feedstock Start* | | | | | |
| | Preferred | | More Preferred | | Most Preferred | |
| | Minimum | Maximum | Minimum | Maximum | Minimum | Maximum |
| | Amount | Amount | Amount | Amount | Amount | Amount |
| Component | (% by wt) | (% by wt) | (% by wt) | (% by wt) | (% by wt) | (% by wt) |
| Nitrogen, total | 5.0 | 10.4 | 6.2 | 9.2 | 6.9 | 8.5 |
| Phosphorus, available | 1.6 | 3.4 | 2.0 | 3.0 | 2.3 | 2.8 |
| Potassium, soluble | 2.0 | 4.1 | 2.4 | 3.6 | 2.7 | 3.3 |
| Magnesium, total | 0.8 | 1.6 | 1.0 | 1.4 | 1.1 | 1.3 |
| Sulfur, total | 5.7 | 11.7 | 7.0 | 10.4 | 7.8 | 9.6 |
| Iron, total | 2.0 | 4.2 | 2.5 | 3.7 | 2.8 | 3.4 |
| Ferrous, total | 1.9 | 3.9 | 2.3 | 3.4 | 2.6 | 3.1 |
| Ferric, total | 0.2 | 0.3 | 0.2 | 0.3 | 0.2 | 0.3 |
| Calcium, total | 0.003 | 0.007 | 0.004 | 0.006 | 0.005 | 0.006 |
| Sodium, total | 0.014 | 0.029 | 0.017 | 0.026 | 0.019 | 0.023 |
| Organic content | 27.5 | 57.0 | 33.8 | 50.7 | 38.0 | 46.5 |
| Water content | 3.6 | 7.4 | 4.4 | 6.6 | 5.0 | 6.1 |
| Microbial strains content | 0.020 | 0.041 | 0.024 | 0.036 | 0.027 | 0.033 |
| Encapsulant content | 0.130 | 0.270 | 0.160 | 0.240 | 0.180 | 0.220 |
| Bactericide content | 0.039 | 0.081 | 0.048 | 0.072 | 0.054 | 0.066 |

The invention has been shown in several embodiments. It should be apparent to those skilled in the art that the invention is not limited to these embodiments, but is capable of being varied and modified without departing from the scope of the invention.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary of the Invention” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

1. A natural and certifiable as organic plant nutrient composition comprising resins, binder components, and plant nutrient compounds.

2. A composition according to claim 1, wherein the resins have melting points of about 50° C. to about 400° C.

3. A composition according to claim 1, wherein the resins in the composition are in an amount of from about 2% to about 40% by weight.

4. A composition according to claim 1, wherein the resins are polymers.

5. A composition according to claim 1, further comprising about 90% by weight of plant nutrient compound and about 10% by weight of resins for adequate mechanical strength and physical integrity.

6. A composition according to claim 1, wherein the natural and certifiable as organic plant nutrient composition is configured to be stored in a reservoir and supplied to a poke stick.

7. A process for treating biological waste to form an organic product, the process comprising:
(a) breaking down the biological waste to form biological particles of substantially small size and relatively homogeneous composition; and
(b) chemically treating the biological particles with reactants.

8. A process according to claim 7, wherein the organic product is a natural and certifiable as organic fertilizer, animal nutrient, or plant nutrient.

9. A process according to claim 7, wherein the biological waste is selected from the group consisting of animal waste, plant waste, processed animal byproducts, processed plant byproducts, animal feed, and waste feedstocks.

10. A process according to claim 7, wherein the process of breaking down the biological waste consist of grinding, hammer-milling, blending, or mixing.

11. A process according to claim 7, wherein the chemically treating the biological particles occurs substantially at a temperature of less than 90° C.

12. A process according to claim 7, further comprising chemical solutions added to the biological waste to create a natural and certifiable as organic liquefied emulsion plant nutrient composition.

13. A process according to claim 12, wherein the chemical solutions comprise beneficial microbes.

14. A process according to claim 7, further comprising encapsulates and encapsulation components added to the biological waste.

15. A process according to claim 7, further comprising real-time chemical analysis, monitoring, and control, for improved accuracy and uniformity of manufacturing the organic product.

16. A process according to claim 7, wherein the treated biological waste has a substantially buffered near neutral pH composition.

17. A process according to claim 7, wherein the treated biological waste is substantially odor free in both dry and wet forms.

18. A process according to claim 7, further comprising grass seeds or plant seeds added to the biological waste.

19. A process according to claim 7, further comprising a packaging process to form poke sticks.

20. A process according to claim 7, wherein the organic product increases the uptake of nitrogen, phosphorous, potassium, and iron in the soil and substantially reduces other biological contaminants.
